(19) United States
(12) Patent Application Publication
(10) Pub. No.: US 2008/0128643 A1
(43) Pub. Date: Jun. 5, 2008

(54) PROJECTION EXPOSURE TOOL FOR MICROLITHOGRAPHY HAVING A RADIATION DETECTOR FOR SPATIALLY RESOLVED REGISTRATION OF ELECTROMAGNETIC RADIATION

(75) Inventors: Ulrich Mueller, Oberkochen (DE); Joachim Stuehler, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 11/855,328

(22) Filed: Sep. 14, 2007

(30) Foreign Application Priority Data
Sep. 15, 2006 (DE) 10 2006 043 406.4

(51) Int. Cl. G01N 21/86

(52) U.S. Cl. 250/559.01

(57) ABSTRACT

A microlithography projection exposure tool with a radiation detector for the locally resolved recording of electromagnetic radiation. The radiation detector comprises: a solid state body which is configured to multiply electric charge and a collector which is configured to determine the location of the multiplied electric charge by means of charge division.

### BACKGROUND TO THE INVENTION

The invention relates to a microlithography projection exposure tool with a radiation detector for the locally resolved recording of electromagnetic radiation and to a method for determining an imaging error of an optical imaging device of a microlithography projection exposure tool. The invention further relates to a mask inspection device with a radiation detector for the locally resolved recording of electromagnetic radiation.

In order to measure optical components in microlithography for semiconductor wafer structuring as regards the imaging quality of the latter, one often falls back upon the so-called aerial image measuring technique. The aerial image measuring technique is unlike a structure-producing measuring technique with which a measured structure is imaged on a photoresist layer of a wafer and the photoresist structure thus produced is then measured. With the aerial image measuring technique an aerial image sensor is used with which the intensity division of a measured object structure being imaged in the three-dimensional space is recorded, locally resolved, in at least one lateral direction in relation to the optical axis of the imaging optics used and in the longitudinal direction of the optical axis. Here, the measurement of the intensity distribution need not necessarily take place in air, but can also take place in some other gaseous medium or in a vacuum.

Typically this happens using a precision table, also called a stage, which is mechanically movable at least in the longitudinal direction. A distinction can basically be made here between imaging techniques and scanning techniques. With scanning techniques the aerial image sensor is moved mechanically in the three-dimensional space and records the radiation intensities at the corresponding points of the space point by point. The aerial image sensor only measures one signal value here at the respective point in time. Therefore the scanning measuring methods lead to long measuring times. High demands are also made of the stability of the precision table and of the measured object. Moreover, with these methods rapid changes over time to the measured object can not be detected.

Object structure sizes on the wafer which are becoming smaller and smaller make greater and greater demands of the mask design and the mask production. Since the image produced by the mask is imaged scaled down on the wafer, weak points on the mask (so-called hot spots) have a particular effect. Moreover, the currently used structure sizes of the critical masks come within the range of the resolution limit of the wafer exposure systems so that the so-called hot spots are becoming more and more dominant. The analysis of defects in the mask production process and in particular in the mask design process is becoming more and more important due to the structures which are becoming smaller and smaller.

In order to analyse mask defects as regards printability, mask inspection devices such as e.g. the AIMS™ (Aerial Imaging Measurement System) of Carl Zeiss SMT AG are established in the market. After the mask design, the mask layout and production of the lithography mask take place. The lithography mask is then examined by the mask inspection device for errors which are then corrected by a repair unit, it generally not being possible to identify all errors. The errors not identified by the inspection unit are then only identified when the wafer is exposed and lead to a high error quota during production. As well as the resulting delays in production the mask repair or the purchase of a new mask lead to substantial extra costs which can increase substantially even further due to costs resulting from the delay in production.

### Underlying Objective

It is an objective of the invention to resolve the aforementioned problems and in particular to provide a microlithography projection exposure tool or a mask inspection device and a method of the type specified at the start with which it is made possible to record an aerial image with improved local resolution and at the same time high sensitivity.

### SOLUTION ACCORDING TO THE INVENTION

The objective is fulfilled according to the invention with a microlithography projection exposure tool which comprises a radiation detector for the locally resolved recording of electromagnetic radiation, the radiation detector having: a solid state body which is configured to multiply electric charge and a collector which is configured to determine the location of the multiplied electric charge by means of charge division.

Furthermore, the objective is fulfilled according to the invention with a method for determining an imaging error of an optical imaging device of a microlithography projection exposure tool. The method according to the invention comprises the steps: providing a radiation detector for the locally resolved recording of electromagnetic radiation, the radiation detector having a solid state body which is configured to multiply electric charge and a collector which is designed to determine the location of the multiplied electric charge by means of charge division, imaging a measured object structure by means of the imaging device, placing the radiation detector in the path of the rays of the optical imaging device on the image side, recording an intensity distribution of electromagnetic radiation produced by the imaging of the measured object structure by means of the radiation detector by converting the electromagnetic radiation produced by imaging the measured object structure into electric charge, multiplying the electric charge by means of the solid state body, and determining the location of the multiplied electric charge by means of the collector, determining the imaging error of the optical imaging device by evaluating the recorded intensity division, and removing the radiation detector from the path of the rays of the optical imaging device.

Furthermore, the objective is fulfilled according to the invention with a mask inspection device with a radiation detector for the locally resolved recording of electromagnetic radiation, the radiation detector having: a solid state body which is configured to multiply electric charge and a collector which is configured to determine the location of the multiplied electric charge by means of charge division.

Furthermore, provided according to the invention is: a microlithography projection exposure tool for exposing a semiconductor wafer with electromagnetic radiation in the EUV and/or higher frequency wavelength range with a radiation detector which is designed to record the hit location of an individual photon of the electromagnetic radiation at a given point in time.

In other words, the radiation detector contained in the microlithography projection exposure tool according to the invention or the mask inspection device according to the invention has a solid state body in which the electric charge is multiplied. Therefore, the multiplication of the electric charge does not take place in a gas or in a vacuum, between two individual dynodes for example, but in a solid state body. The solid state body in accordance with the invention can be made of a uniform material. However, it can also have several layers of different material.

Furthermore, the radiation detector has a collector for the locally resolved recording of the multiplied electric charge by means of charge division. Therefore, by dividing the multiplied electric charge into at least two part charges, an electric signal is produced in the collector from which the site of the location within the extension of the collector can be determined. Therefore the site of the location within the extension of the collector with a local resolution which is smaller than the extension of the collector can be determined from the electric signal.

The design according to the invention of the solid state body means that the whole charge multiplication process takes place within the solid state body and so the electric charge does not pass out of the solid state body during the multiplication process. Therefore, spatial distribution or local “smearing” of the electric charge is greatly reduced. Due to Coulomb interaction between the individual charge carriers, each charge cloud has a certain extension or “smearing”. By means of the locally resolving collector furthermore provided according to the invention, following amplification the location of the focal point of the amplified or multiplied electric charge can be determined In at least one recording direction, and so in at least one dimension of the three-dimensional space or along at least one spatial axis. The spatial axis can run parallel to a co-ordinate axis or adopt any orientation within the space. The at least one spatial axis advantageously extends laterally to a radiation direction of the electromagnetic radiation.

Advantageously the solid state body is designed such that local “smearing” of the electric charge in a direction parallel to the at least one spatial axis is especially reduced. By means of the overall design as a solid state body, “smearing” of the multiplied electric charge is reduced such that the center of gravity of the charge cloud does not change substantially due to the “smearing”. Furthermore, the extension of the charge cloud can be limited such that the latter is no greater than the extension of the collector. Therefore, the focal point of the multiplied electric charge can be determined with high resolution within the extension of the collector.

Since according to the invention the electric charge is not substantially “smeared” locally during the multiplication process, the determined location of the multiplied electric charge corresponds in at least one dimension or recording direction with great precision to the location at which the electromagnetic radiation radiates onto the radiation detector as regards the position of the latter in the at least one dimension. The spatial axis defining this dimension is preferably aligned at right angles to the direction in which the electromagnetic radiation reaches the radiation detector. The location at which the electromagnetic radiation radiates onto the radiation detector and the location of recording the multiplied electric charge can differ by a constant offset vector or also by a previously known offset vector dependent upon the respective receiving location. The possible receiving locations of the electromagnetic radiation can therefore be assigned to the recording locations for the electric charge, for example by means of a field of offset vectors determined by calibration.

Preferably, the collector is designed to record the location of the electric charge in a plane lateral to the direction in which the electromagnetic radiation arrives. By providing, according to the invention, the solid state body for multiplying the electric charge, the radiation detector has high sensitivity. Electromagnetic radiation with very low intensity can therefore also be recorded by means of the radiation detector according to the invention with high local resolution. In particular it is possible to determine the hit location of individual photons of the electromagnetic radiation. There is therefore no real lower intensity limit, but only an “endurance limit” in order to achieve a specific statistical certainty.

In one embodiment according to the invention the radiation detector is designed for the locally resolved recording of electromagnetic radiation in the EUV wavelength range. Here the radiation detector preferably has a photoelectric element which is designed to receive the electromagnetic radiation with a radiation wavelength in the EUV wavelength range (extreme ultraviolet radiation) and to convert it into the electric charge. Unlike infrared radiation, for which avalanche photodiodes are generally designed, a photon does not just produce one electron in the EUV wavelength range, but substantially more, e.g. 20 electrons. This makes it possible to design the solid state body according to the invention for multiplying charge only to a moderate amplification, e.g. to amplification by the factor of 100. The radiation detector can therefore have relatively small dimensions. This substantially simplifies the use of the radiation detector in a microlithography projection tool.

In other words, the radiation detector according to one embodiment according to the invention is provided with a photoelectric element which is designed to receive electromagnetic radiation in the EUV wavelength range, and to produce electric charge from this. In one embodiment the photoelectric element is designed to receive and convert electromagnetic radiation which is produced by means of discharge and/or laser plasma sources. In a further embodiment the photoelectric element is particularly sensitive with electromagnetic radiation with the wavelength 13.5 nm. Preferably a photon of the electromagnetic radiation produces at least one charge carrier, in particular an electron.

In microlithography for semiconductor wafer structuring it is still the trend to use shorter and shorter exposure wavelengths. As part of this trend one is currently working intensively on the use of EUV radiation for wafer structure exposure, i.e. on the use of exposure radiation in the extreme UV range and in the soft X-ray range. Microlithography projection units with this type of exposure radiation are provided for wafer structuring with minimum structure widths of between approximately 32 nm and 11 nm. In order to be able to make full use of the short exposure wavelengths in order to produce structures with such low minimum dimensions the exposure optics should have correspondingly high resolution. Therefore apparatuses for measuring corresponding optical components with correspondingly high precision and local resolution are required.

Since EUV radiation or radiation with higher frequency wavelengths for wafer structuring with very small minimum structure widths in the range of 20 nm and less should be used, the high local resolution achievable by means of the radiation detector according to the invention is important in order to measure the imaging quality of the optics used in the lithography. An aerial image measuring device with the aforementioned radiation detector makes it possible to measure the electromagnetic radiation in the EUV wavelength range with a very high local resolution. By means of an apparatus for determining an imaging error of an optical imaging device which comprises this aerial image measuring device the imaging error can be determined with very high precision, in particular with a precision which is smaller than the wavelength of the electromagnetic radiation used. The microlithography projection exposure tool according to the invention which comprises this apparatus can therefore be calibrated with corresponding precision. In a further embodiment according to the invention the radiation detector is designed for the locally resolved recording of electromagnetic radiation in the wavelength range with higher frequency in relation to EUV or in the EUV and higher frequency wavelength range.

In a further embodiment according to the invention the microlithography projection exposure tool is designed to expose a semiconductor wafer with electromagnetic radiation in the EUV and/or higher frequency wavelength range.

In a further embodiment according to the invention the radiation detector has a photoelectric element which is configured to receive the electromagnetic radiation and to convert it directly into the electric charge. Unlike indirect conversion of the electromagnetic radiation, for example by means of upstream scintillators or phosphors, the electromagnetic radiation, in particular in the EUV wavelength range, is converted according to the invention directly into the electric charge. This makes high conversion efficiency possible, by means of which correspondingly small dimensioning of the radiation detector becomes possible. This substantially simplifies the use of the radiation detector in a microlithography projection tool.

In a further embodiment of the microlithography projection exposure tool according to the invention, in one recording direction the radiation detector has an extension of maximum 20 μm, and in particular of maximum 10 μm. Therefore, the radiation detector has dimensioning which substantially simplifies the use of the radiation detector in the microlithography projection tool. In one embodiment of the mask inspection device according to the invention the radiation detector has in one recording direction an extension of maximum 200 μm, and in particular of maximum 100 μm. Therefore the radiation detector has dimensioning which substantially simplifies the use of the radiation detector in the mask inspection device.

In a further embodiment according to the invention the collector comprises a discreet electric component which has an extension in at least one recording direction and is designed to receive the multiplied electric charge at one location along the recording direction, and the discreet electric component is designed to produce, by dividing the received multiplied electric charge into at least two part loads, an electric signal from which the site of the location within the extension of the component can be determined. The discreet electric component can e.g. contain a resistance element or a capacitor. The discreet electric component has an extension in at least one recording direction and is designed to receive the multiplied electric charge at one location. The discreet electric component can be part here of a larger solid state body, but is unsegmented in design at least in the region of its extension. The multiplied electric charge preferably distributes in the component by itself to at least two measuring points. By providing the discreet electric component by means of which the site of the location of the multiplied electric charge can be determined within the extension of the latter, particularly high local resolution is possible. Unlike location recording by means of a segmented detector, such as for example a field of pixel detectors, the electric component has a continuous recording region over its extension. The site of the location can therefore be determined independently of a recording grid. The discreet electric component is in any case formed as one part or one piece along its extension. Therefore, along the spatial axis the collector has a structural width which exceeds the pre-specified local resolution. Advantageously the extension of the longitudinal section formed as one part in the recording direction exceeds the local resolution by at least one unit of size, preferably by two or more units of size. The radiation detector with very high local resolution can therefore be produced inexpensively. Furthermore, the radiation detector is less susceptible to malfunctions due to the one-piece design of the collector.

In a further embodiment according to the invention the collector furthermore has an evaluation apparatus which is designed to determine the site of the location from the electric signal.

In a further embodiment according to the invention the solid state body is designed to multiply the electric charge by at least a factor of 100, and in particular by at least a factor of 1000. It is therefore possible by means of the collector to record the site of the location of the multiplied electric charge with improved precision. The sensitivity of the radiation detector is substantially increased.

Since the site of the location is determined by charge division, the resolution with which the site of the location can be established acts substantially inversely proportionally to the amplification of the electric charge. By using a discreet electric component with a pre-specified extension in one recording direction, the site of the location of the amplified electric charge within the extension can be determined maximally with a precision which is determined by the quotient of the extension over the number of charge carriers in the amplified electric charge. If the electric charge is amplified for example to 100 electrons, the maximum resolution achievable by means of charge division is approximately one hundredth of the extension. By amplifying the electric charge by at least a factor of 100 the local resolution of the radiation detector can therefore be substantially increased.

In a further embodiment according to the invention the radiation detector is designed for the locally resolved recording of electromagnetic radiation with a pre-specified local resolution, and the solid state body is designed to amplify the electric charge such that the overall number of resulting electric charge carriers is at least as great as the quotient of the extension of the discreet electric component and the local resolution.

In one embodiment according to the invention the discreet electric component has a resistance element, in particular a locally resolving electrode. By means of this type of resistance element the amplified electric charge can be recorded, locally resolved, with particularly small effort. At one recording location of the resistance element incoming electric charge is discharged to both ends of the resistance element along the recording direction. Due to the different path length from the recording location to the respective end points of the resistance element which preferably has a homogeneous specific resistance, different part resistances are produced for the part sections between the recording location and the two end points of the resistance element. From the ratio of the part currents respectively occurring at the end points of the resistance element one can infer the resistance ratio and so the recording location of the incoming electric charge. In an alternative embodiment the collector has a capacitor extending along the at least one spatial axis. This type of capacitor can also be operated as a locally sensitive electrode. For the local resolution of the incoming electric charge the respective reactances on both sides of the recording location are determined. From the ratio of the reactances the precise recording location of the electric charge then emerges in the same way as the aforementioned resistance element. This type of resistance element can in particular also be two-dimensional in form and be provided with at least three connections for the two-dimensional location measurement.

In a further embodiment according to the invention the evaluation apparatus is designed to read out current strengths of the discreet electric component that occur at different read-out points, in particular at two end points, and to determine the site of the location of the multiplied electric charge within the extension of the component from the current strengths read out. The read-out apparatus preferably has an analogue or digital calculator with which the sum of and the difference between the part currents occurring at the read-out points of the component and the quotient of the difference and the sum can be calculated. The value of this quotient is proportional to the recording location of the charge being received. In one embodiment of the evaluation apparatus, with pulsed radiation signals and with the help of integral preamplifiers the time integral of the part currents is first of all respectively calculated by means of the pulse duration. From the integral part currents the aforementioned totals, differences and quotients are then established. Furthermore, it is advantageous if a trigger logic is provided with which the integral preamplifiers are reset before the pulse, and if furthermore a memory chip is provided with which the calculation result is established. The signals established are preferably further processed with an analogue to digital converter by using an analogue calculator. By means of a histogram memory the spatial distribution of the photons can be established after a sufficient number of incoming radiation pulses. From this the intensity distribution of an aerial image for example emerges. By reading out at two read-out points, the site of the location can be determined one-dimensionally. In one embodiment according to the invention the site of the location is determined two-dimensionally at three or more read-out points by means of an analogue read-out. In one embodiment according to the invention the current read-out apparatus is disposed directly adjacent to the locally resolving collector. Therefore short line lengths are possible, by means of which a position measurement with a small error deviation can be taken.

The evaluation apparatus is advantageously based upon a coincidence technique with which one can infer that a photon has reached the radiation detector from the part currents occurring at the same time. The photodetector has a certain down time here after each photon. With a pre-specified irradiation strength the photons are spaced apart from one another by the maximum time when the irradiation is continuous. With pulsed irradiation it should be ensured that the likelihood of receiving a photon in the pulse is smaller than one. This is the case with conventional assumptions regarding down time, irradiation strength and spot size in the exposure tool with repetition rates of >4 kHz. In particular, by means of the radiation detector, EUV radiation which is produced from discharge or laser plasma sources with a repetition rate of approximately 4000/sec, can be recorded reliably with a local resolution of approximately 20×20 nm.

In a further embodiment according to the invention the collector or the discreet electric component is formed as one part or integrally with the photoelectric element. The photoelectric element and the locally resolving collector or the discreet electric component form part of a one-part solid state body. A one-part solid state body in accordance with the invention can, as already explained above, be made of a single material or also have several layers of different material. By means of the integral design the charge carriers produced by means of the photoelectric means must not leave the solid state body in order to record their local site. Spatial distribution or local “smearing” of the electric charge is therefore reduced. The electromagnetic radiation can therefore be recorded with a very high local resolution.

In a further embodiment according to the invention the local resolution of the collector or of the discreet electric component lies within the EUV wavelength range. The radiation detector is therefore suitable as a sensor for measuring an aerial image of a microlithographic exposure tool. The structures printed with this type of exposure tool should have a minimum structural width which comes within the dimensions of the radiation wavelength.

In a further embodiment of the microlithography projection exposure tool according to the invention the local resolution of the collector or of the discreet electric component is less than 50 nm and in particular less than 15 nm. It is particularly advantageous if the local resolution is approximately 10 nm. In this case the extension of the discreet component is preferably 10 μm in size. This local resolution facilitates the use of the radiation detector in microlithography with irradiation wavelengths in the EUV range or in the range of higher frequency wavelengths. In one embodiment of the mask inspection device according to the invention the local resolution of the collector or of the discreet electric component is less than 500 nm, and in particular less than 150 nm. This local resolution facilitates the use of the radiation detector in the mask inspection device with irradiation wavelengths in the EUV range or in the range of higher frequency wavelengths.

In a further embodiment according to the invention the photoelectric element, the solid state body and/or the collector or the discreet electric component is or are contained in a detector element in the form of a solid state body. This means that the detector element can contain either the photoelectric element and the collector, the photoelectric element and the solid state body for multiplying the charge, the solid state body for multiplying the charge and the collector or the electric component, or all three elements at the same time. By integrating the aforementioned elements in the detector element in the form of a solid state body, one prevents location uncertainty from being produced between the arrival of the electromagnetic radiation and the recording of the electric charge by means of the collector. By including all three elements in the detector element, the whole process of converting a photon into electric charge, the amplification or multiplication of the electric charge and the recording of the location of the amplified electric charge take place in the detector element in the form of a solid state body. Inflow and outflow of electric charge from the solid state body are thus avoided. The electric charge is therefore prevented from “smearing” to a large extent.

In a further embodiment according to the invention the collector is designed to record the (multiplied) electric charge in the at least one recording direction in the three-dimensional space with a pre-specified local resolution, and the discreet electric component and/or the solid state body has an oblong geometry extending in the at least one recording direction. Advantageously the dimensions of the solid state body are approximately 10 μm×3 μm in size in one plane at right angles to the radiating direction of the electromagnetic radiation. The solid state body can be produced with a silicon base or with a gallium arsenide base. Furthermore, the solid state body can also be designed with a mixed semiconductor base or as a hybrid.

In a further embodiment according to the invention there is an electric guide field in the solid state body for reducing the local distribution of the amplified electric charge in at least the recording direction. This can advantageously be produced by applying a bias to the solid state body. “Smearing” of the electric charge brought about by Coulomb interaction between the charge carriers is thus limited. In particular in this way the extension of the electric charge cloud is prevented from being greater than the extension of the discreet electric component. Any remaining systematic shifts of the charge cloud are generally stable and can therefore be taken into account by appropriate calibration.

In a further embodiment according to the invention the detector element has the basic structure of an avalanche photodiode. In particular, this structure comprises the photoelectric element, the solid state body for multiplying the charge and the discreet electric component. This type of avalanche photodiode has a p and an n zone between which is disposed a transition zone with low doping. When a bias is applied to the diode, relatively high field strengths of several 100 kV/cm form in the transition zone. In this zone radiated electromagnetic radiation is converted into electric charge and amplified at the same time. The electric fields thus produced in the transition zone serve in particular to limit the “smearing” of the amplified electric charge in the recording direction. In the case according to the invention, the solid state body is designed in particular such that electromagnetic radiation in the EUV and/or higher frequency wavelength range is converted in the transition zone. By means of impacts between accelerated charge carriers and the lattice of the avalanche photodiode, ionisation occurs. The newly produced pairs of charge carriers are further accelerated in the field. An amplification cascade is produced. Preferably, the n-zone serves as a locally resolving collector for recording charge carriers in the form of electrons. For this purpose the current read-out apparatus mentioned above can be connected at the ends of the avalanche photodiode in the region of the n zone. Alternatively, the p zone can also serve as a locally resolving collector, in this case for recording charge carriers in the form of holes.

In a further embodiment according to the invention the radiation detector is designed to record the hit location of an individual photon of the electromagnetic radiation in at least one recording direction at a given point in time. Furthermore, it is advantageous if an evaluation apparatus is provided which has a histogram memory and which is set up to record the respective hit location of individual photons of the electromagnetic radiation hitting the radiation detector one after the other and to input this into the histogram memory, and so record a locally resolved hit frequency of the individual photons of the electromagnetic radiation.

In a further embodiment according to the invention the microlithography projection exposure tool comprises an aerial image measuring device containing the radiation detector which is designed for measuring an intensity distribution of electromagnetic radiation in the three-dimensional space, in particular by recording the hit locations of individual photons of the electromagnetic radiation in a chronological sequence. The intensity distribution is produced by imaging a measured object structure by means of an optical imaging device. A microlithographic measured structure can in particular be considered as a measured object structure for determining imaging errors in optical elements of the microlithography projection exposure tool. With the aerial image measuring device mentioned above with the radiation detector according to the invention, the radiation detector is preferably movably mounted such that the intensity distribution of the electromagnetic radiation can take place at least in the direction of the optical axis and in a direction at right angles to this. The measurement can be taken in air, in some other gaseous medium or in a vacuum. The aerial image measuring device comprising the radiation detector according to the Invention makes it possible to measure an intensity distribution of electromagnetic radiation with high sensitivity and high local resolution.

In one embodiment of the aerial image measuring device according to the invention the latter has at least two radiation detectors which are designed to record, locally resolved, the electromagnetic radiation along a respective main recording direction, the radiation detectors being arranged such that their respective main recording directions are aligned differently within the three-dimensional space, and in particular are positioned at right angles to one another. If the optical axis of an optical imaging device to be measured extends for example along the z direction, e.g. a first radiation detector can be positioned such that its main recording direction extends in the x direction, whereas the main recording direction of the second radiation detector is aligned in the y direction. In particular, the radiation detectors are designed respectively as one-dimensional radiation detectors.

In a further embodiment according to the invention the aerial image measuring device has a precision table movable within the three-dimensional space and onto which the at least one radiation detector is fixed. In particular, the aforementioned at least two radiation detectors with different main recording devices are attached to the precision table.

In a further embodiment according to the invention the microlithography projection exposure tool has an optical imaging device and an apparatus for determining an imaging error of the optical imaging device, the apparatus comprising: a measured object structure to be imaged and the aerial image measuring device which is set up for the locally resolved determination of an intensity distribution of electromagnetic radiation in the three-dimensional space produced by the optical imaging device by imaging the measured object structure. The apparatus containing this aerial image measuring device for determining an imaging error of an optical imaging device makes it possible to determine the imaging error with very high precision and at the same time low radiation intensity. Therefore, optical components, in particular the projection optics of the microlithography projection illumination tool according to the invention having the apparatus can be calibrated and adjusted with high precision.

Advantageously, the microlithography projection exposure tool according to the invention has an evaluation apparatus for determining the imaging error of the optical imaging device from the determined intensity distribution. By means of the aerial image measuring device imaging errors of an optical imaging device of a microlithography projection exposure tool can be determined. This type of optical imaging device can be the projection optics, but also the illumination optics of the microlithography projection exposure tool.

Moreover it is advantageous if the apparatus has at least two differently aligned measured object structures. In the case of using different radiation detectors with different main recording directions, it is preferable to use measured object structures the respective orientation of which is adapted to the main recording directions of the radiation detectors. Furthermore it is advantageous if the apparatus has a measuring mask which has the at least one measured object structure to be imaged. The measured object structure can in particular have lines.

In a further embodiment according to the invention the microlithography projection exposure tool comprises an optical imaging device for imaging a product mask disposed in a mask plane on a semiconductor wafer disposed in a wafer plane and a diffused light measuring apparatus for measuring a proportion of diffused light in the microlithography projection exposure tool, the diffused light measuring apparatus having: a measuring mask disposed in the mask plane with a test structure which attenuates the exposure radiation more strongly in relation to a mask region surrounding the test structure, and the aforementioned radiation detector which is disposed in the wafer plane in a dark region of the test structure in which reduced radiation intensity occurs when imaging the measuring mask in the wafer plane due to the test structure. Advantageously the apparatus further comprises an evaluation unit for determining the proportion of diffused light from the radiation intensity which strikes and the illumination intensity. The test structure used is designed so to say as a dark structure on a light background, and so has the effect of attenuating the radiation or being impermeable to radiation with respect to electromagnetic radiation in the EUV and/or higher frequency wavelength range. The test structure can e.g. be rectangular or square in form. The radiation detector is located in the dark region of the image and counts the photons which nevertheless still reach this point. By making a comparison with the illumination intensity of the mask, the proportion of diffused light of the microlithography exposure tool can be determined from this particularly efficiently and with a high degree of precision. Furthermore, the radiation detector according to the invention makes it possible to record the light intensity arriving, locally resolved, at the dark region of the image in relation to the extension of the dark region. In a further embodiment according to the invention the evaluation unit is designed to read out from the radiation detector the radiation intensity hitting the radiation detector in relation to the dark region of the test structure, locally resolved, and from this to establish the proportion of diffused light resolved over the range. This saves a great deal of measuring time in comparison, for example, with a test with differently dimensioned darkened regions. With the diffused light measurement the requirements for local resolution with respect to the aerial image measurement in the microlithography projection exposure tool are less stringent. Local resolutions of between 100 nm and 1 μm are often sufficient. Therefore, the radiation detector can be designed with greater dimensions.

In a further embodiment of the microlithography projection exposure tool according to the invention a wafer stage is provided for movably holding a semiconductor wafer during exposure operation of the microlithography projection exposure tool, the at least one radiation detector being fixed to the wafer stage. The wafer stage therefore serves as a precision table. Preferably, during exposure operation of the microlithography projection exposure tool the imaging error of the imaging device is measured between the exposures of the individual wafers or between the exposures of individual wafer sections (so-called “dies”). The measurement result is used to readjust the imaging device.

Furthermore, it is advantageous if the microlithography projection exposure tool has a radiation source which is designed to produce electromagnetic radiation in the EUV and/or higher frequency wavelength range, in particular with a wavelength of 13.5 nm. The radiation source is for example a pulsed discharge and/or laser plasma source. In the preferred embodiment the repetition rate is approximately 4000/sec. Alternatively a continuous radiation source can also be used.

Furthermore, it is advantageous if the radiation source is designed both for exposing a semiconductor wafer and for determining an optical imaging error of the optical imaging device by means of the assigned apparatus.

In one embodiment of the method according to the invention the measured object structure is irradiated during imaging by means of the imaging device with electromagnetic radiation in the EUV and/or higher frequency wavelength range. In a further embodiment according to the invention the recording of the intensity distribution of the electromagnetic radiation comprises the following steps: recording the respective hit locations of individual photons of the electromagnetic radiation hitting the radiation detector one after the other, and inputting the hit locations recorded into the histogram memory and so recording a locally resolved hit frequency of the individual photons of the electromagnetic radiation.

The features specified in relation to the embodiments of the microlithography projection exposure tool and the mask inspection device according to the invention listed above can be correspondingly transferred to the method according to the invention. The embodiments of the apparatus according to the invention resulting from this shall be specifically included by the disclosure of the invention. Furthermore, the advantages listed above in relation to the embodiments of the microlithography projection exposure tool and mask inspection device according to the invention therefore also relate to the corresponding embodiments of the method according to the invention.

### BRIEF DESCRIPTION OF THE DRAWINGS

In the following an exemplary embodiment of a microlithography projection exposure tool according to the invention and of a mask inspection device according to the invention are described in greater detail by means of the attached diagrammatic drawings. These show as follows:

FIG. 1 a diagrammatic illustration of an embodiment of a microlithography projection exposure tool according to the invention with a projection objective and an apparatus for determining an imaging error of the projection objective with a radiation detector,

FIG. 2 a side view of a part of the system of FIG. 1,

FIG. 3 an embodiment of the radiation detector for the locally resolved recording of electromagnetic radiation with a current read-out apparatus,

FIG. 4 a circuit diagram illustrating the principle of determining location by means of charge division,

FIG. 5 a circuit diagram illustrating a current read-out apparatus according to FIG. 3, and

FIG. 6 a diagrammatic illustration of an embodiment of a mask inspection device according to the invention.

### DETAILED DESCRIPTION OF ADVANTAGEOUS EXEMPLARY EMBODIMENTS

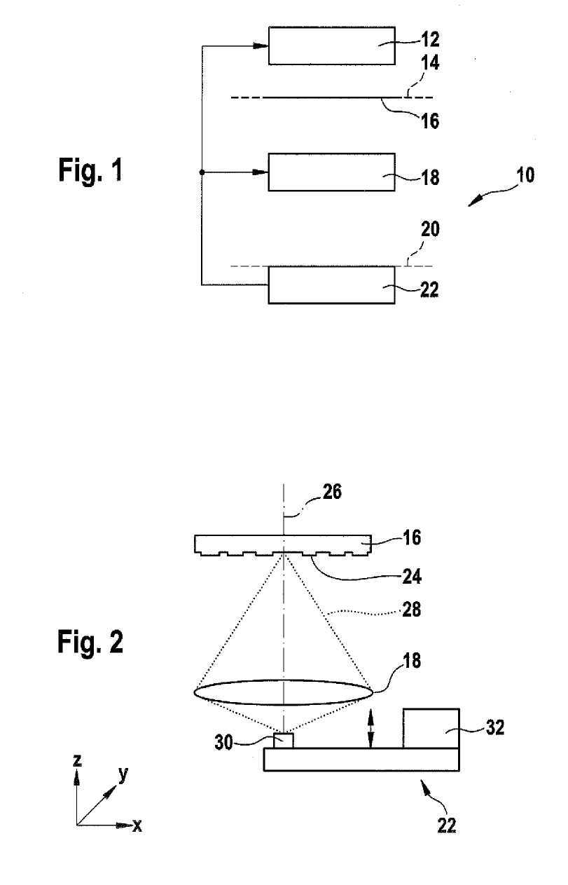

FIG. 1 diagrammatically illustrates in the block diagram a microlithography projection exposure tool 10 for EUV microlithography and an apparatus assigned to the latter for determining imaging errors. The microlithography projection exposure tool 10 is of conventional design, only the components currently of interest here being representatively reproduced in FIG. 1, namely a radiation source 12 in the form of an illumination system for producing EUV exposure radiation, for example with a wavelength of 13.5 nm and a highly resolving projection objective 18 for imaging mask structures which can be positioned in an object plane 14, for example by means of a conventional reticle stage.

During normal exposure operation, not shown here, the projection objective 18 images the mask structure placed on the object side on the image side of a wafer or on a photoresist layer applied to the latter, for which the wafer is positioned as normal, for example by means of a wafer stage, in an image plane 20 of the projection objective 18. The projection exposure tool 10 can be of any of the conventional types, in particular of the scanner or stepper type. The invention comprises in the same way microlithography projection exposure tools which function with exposure radiation of other wavelengths, in particular in the EUV range, but also in all other wavelength ranges conventionally used for this purpose.

In FIG. 1 the projection exposure tool 10 is shown in a measuring operation type with which the assigned apparatus for determining imaging errors is coupled and activated in order to measure the projection objective 18 with regard to imaging errors. This apparatus is based upon a so-called aerial image measuring technique and for this purpose comprises a measuring mask 16 to be positioned on the object side, i.e. in the path of the rays in front of the projection objective 18, and an aerial image measuring device 22 to be positioned on the image side, i.e. in the path of the rays after the projection objective 18.

FIG. 2 illustrates the aerial image measuring technique and shows the measuring mask 16, the projection objective 18 and the aerial image measuring device 22 in a diagrammatic side view. The measuring mask 16 supports a measured object structure 24 to be imaged and which is preferably positioned in the object plane 14 of the projection objective 18, for example by disposing the measuring mask 16 on the reticle stage. The measured object structure 24 is illuminated by electromagnetic radiation 28 in the EUV wavelength range in the form of measuring radiation, and is imaged by the projection objective 18 such that in the image plane 20 of the projection objective 18 a so-called aerial image is produced which is recorded and evaluated by the aerial image measuring device 22. The projection objective 18 is only shown diagrammatically in FIG. 2 and can be imaged refractively or reflectively depending on the illumination wavelength. In this case in which the illumination wavelength comes within the EUV wavelength range, the projection objective is preferably imaged reflectively. For this purpose the aerial image measuring device 22 is of a design known in its own right and therefore not shown in greater detail here, of which in FIG. 2 a movable precision table 32 and a radiation detector 30 designed according to the invention and attached to said precision table are representatively reproduced. The precision table 32 can for example be a conventional wafer stage or a stage which is provided for the measuring operation instead of the wafer stage. In the example shown the precision table 32 is movable both in the longitudinal direction (z direction), i.e. parallel to the optical axis 26 of the optical system being examined, here the projection objective 18, and in the lateral plane at right angles to this (xy plane). In this way the radiation detector 30 can be shifted along the focus direction of the projection objective 18 as required and be moved away laterally over the aerial image.

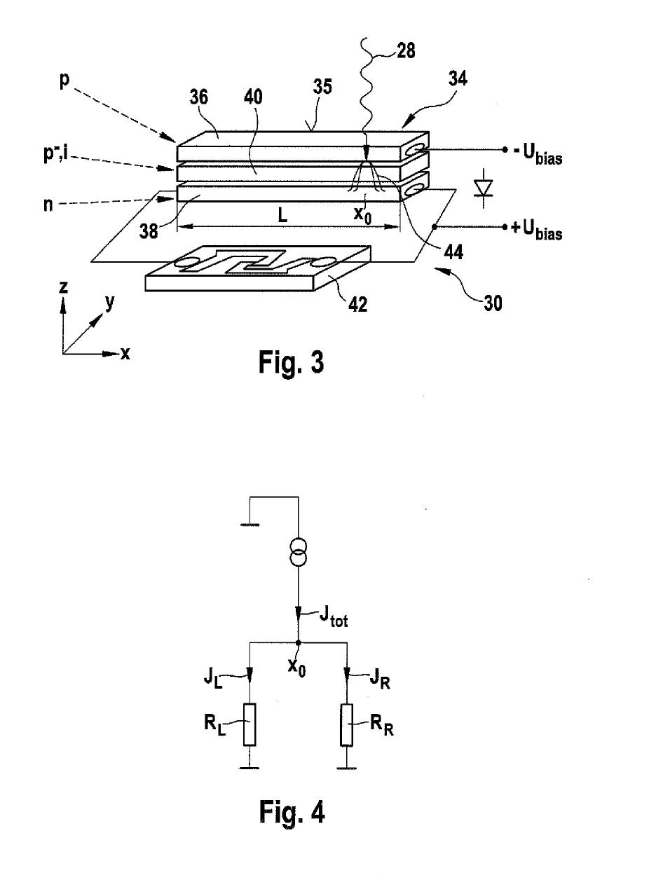

FIG. 3 illustrates the design of an embodiment of the radiation detector 30 according to the invention as used according to the invention in the aerial image measuring device 22 according to FIG. 2. The radiation detector 30 comprises a detector element 34 which, as in the example shown, can be in the form of a solid state body, and an evaluation apparatus 42 attached to the latter in the form of a current read-out apparatus. The detector element 34 is cuboid in form and has an oblong geometry extending in one dimension in the three-dimensional space in the co-ordinate system of FIG. 3 along the x co-ordinate axis. In the example shown the edge length L of the detector element 34 along the x co-ordinate axis is 10 μm. The edge length along the y co-ordinate axis is approximately 3 μm in the example shown.

The detector element 34 has a receiving surface 35 for receiving electromagnetic radiation 28 in the EUV wavelength range. For measuring the aerial image in the arrangement according to FIG. 2 the detector element 34 is aligned such that the electromagnetic radiation 28 hits the receiving surface 35 substantially at right angles. According to FIG. 3 zones with different doping extend parallel to the receiving surface 35, parallel to the x-y plane, in the detector element 34. The basic structure of the detector element 34 corresponds to that of an avalanche photodiode. The receiving surface 35 is adjacent to a p-doped zone 36 to which a relatively thick zone 40 with low doping and an n-doped zone 38 adjoin. The zone 40 forms a solid state body which is configured to multiply electric charge. The solid state body of zone 40 can form part of this solid state body. The zone 38 forms a collector which is configured to determine the location of the multiplied electric charge by means of charge division. A photon of the incoming electromagnetic radiation 28 is converted with low doping into electric charge 44 in the form of at least one electron at a transition between the p zone 36 and the zone 40.

A bias (+/−U_{bias}) is applied between the p zone 36 and the n zone 38. In the zone with low doping a relatively high field strength of several 100 kV/cm forms. The electric charge 44 produced by the electromagnetic radiation 28 is accelerated in the zone 40 with lower doping as a result of which ionisation occurs due to impacts between the accelerated electrons and the lattice of the solid state body of the detector element 34. An amplification cascade is produced with the result that the electric charge 44 is amplified and multiplied by several units of size. Therefore, each EUV photon with for example 92 eV energy in the semiconductor produces up to twenty electron-hole pairs. In an exemplary multiplication of the electric charge 44 by the factor 100 on average more than 2000 electrons are produced per EUV photon.

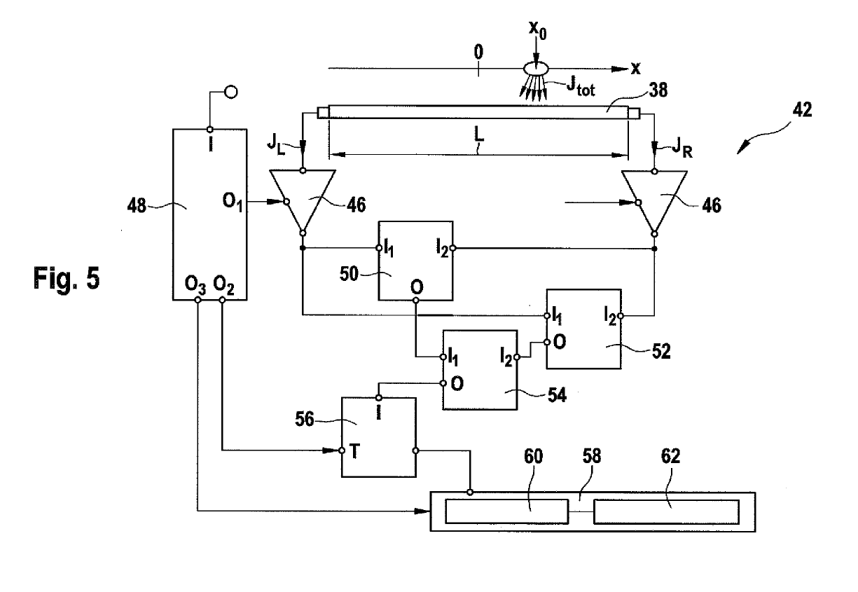

The n zone 38 acts as a locally resolving collector for determining the co-ordinate xₒ of the location of the multiplied electric charge 44. The two face surfaces of the n zone 38 extending parallel to the y-z plane are connected to the evaluation apparatus 42. The principle of determining the co-ordinate xₒ of the location of the electric charge 44 is illustrated diagrammatically in FIG. 4. In the illustration according to FIG. 3 the n zone 38 has in its section to the left and to the right of the location xₒ a resistance R_{L} and a resistance R_{R}. The n zone 38 acting as the resistance element is also illustrated diagrammatically in FIG. 5. If one starts with a total length L of the n zone 38 along the x co-ordinate axis, the resistances R_{L} and R_{R} dependently upon the co-ordinate xₒ of the location of the multiplied electric charge 44 can be illustrated as follows:

$$\begin{matrix}{R}_{L} ( x ) = ρ \cdot \frac{L / 2 + {x}_{0}}{A} \\ and & ( 1 ) \\ {R}_{R} ( x ) = ρ \cdot \frac{L / 2 - {x}_{0}}{A} & ( 2 )\end{matrix}$$

ρ being a specific resistance assumed to be homogeneous, and A being the cross-section of the n zone 38.

The total current Jₜₒₜ generated by means of the multiplied electric charge 44 divides as follows into the two portions J_{L} and J_{R}:

Jₜₒₜ=J_{L}+J_{R} (3)

This produces the x co-ordinate xₒ of the location of the electric charge 44 as follows:

$${x}_{0} = \frac{{J}_{R} - {J}_{L}}{{J}_{R} + {J}_{L}} \qquad ( 4 )$$

By means of the evaluation apparatus 42 shown in detail in FIG. 5 xₒ is evaluated according to the equation (4). Here the evaluation apparatus 42 first of all has integral preamplifiers 46 which with pulsed incoming electromagnetic radiation 28 first of all integrate the currents over the pulse duration. Further processing then takes place by means of an adder 50, a subtractor 52 and an electronic chip 54 for forming a quotient. The result of the signal processing is established by a memory chip 56. The memory chip 56 is also associated with a further electronic chip 58 for reading out the quotient. The further electronic chip 58 can have e.g. a digital interface for reading out the data with an analogue to digital converter 60 and an associated histogram memory 62. The integral preamplifier 46, the memory chip 56 and the further electronic chip 58 are controlled by a trigger logic 48. The trigger logic 48 ensures that the integral pre-amplifier 46 is reset before a signal pulse and the calculation result is established after the signal pulse by the memory chip 56. The evaluation apparatus 42 is synchronised in accordance with the radiation intensity such that for every photon hitting the receiving surface 35 the resulting amplified electric charge 44 is read out. Therefore, the locally resolving radiation detector 30 according to the invention makes it possible to record the hit location of an individual photon of the electromagnetic radiation at a given point in time. The evaluation apparatus is based upon a coincidence technique with which it can be concluded that a photon has hit the radiation detector 30 from the part currents J_{L} and J_{R} hitting at the same time. The hit locations recorded one after the other are input into the histogram memory 62. The resulting histogram reproduces the locally resolved hit frequency of the individual photons of the electromagnetic radiation. The radiation detector 10 according to the invention enables local resolution of the incoming EUV radiation of less than 50 nm.

It is to be understood that locally resolving radiation detectors according to the invention are not only suitable as aerial image detectors for the purpose of measuring imaging errors of optical components of microlithography projection exposure tools of all types, but moreover are also suitable for detecting aerial images of any other applications of the aerial image measuring technique and in general for any applications which require locally resolved detection of the illumination strength of a radiation. The invention is suitable in particular for detecting radiation of any EUV wavelength and so for EUV applications, but it is not restricted to this. For example therefore, radiation in the normal UV range can also be recorded, locally resolved, with the radiation detectors according to the invention.

Furthermore, the radiation detector 30 according to the invention can be used to measure a proportion of diffused light in a microlithography projection exposure tool 10 designed for exposure radiation in the EUV and/or higher frequency wavelength range with an optical imaging device 18 for imaging a product mask disposed in a mask plane 14 on a semiconductor wafer disposed in a wafer plane 20. For this purpose a measuring mask 16 is disposed in the mask plane 20, the measuring mask 16 having a test structure which attenuates the exposure radiation more strongly in relation to a mask region surrounding the test structure, the radiation detector 30 is disposed in the wafer plane 20 in a dark region of the test structure in which a reduced radiation intensity occurs when imaging the measuring mask in the wafer plane due to the test structure, the measuring mask 16 is illuminated with the exposure radiation of a specific illumination intensity, the radiation intensity hitting the radiation detector 30 is registered, and the proportion of diffused light from the incoming radiation intensity and the illumination intensity is determined. Furthermore, the radiation detector according to the invention makes it possible to record, locally resolved, the light intensity arriving in the dark region of the image and the extension of the dark region. It is therefore possible to establish the range distribution of the diffused light as well as the proportion of diffused light in general at the same time.

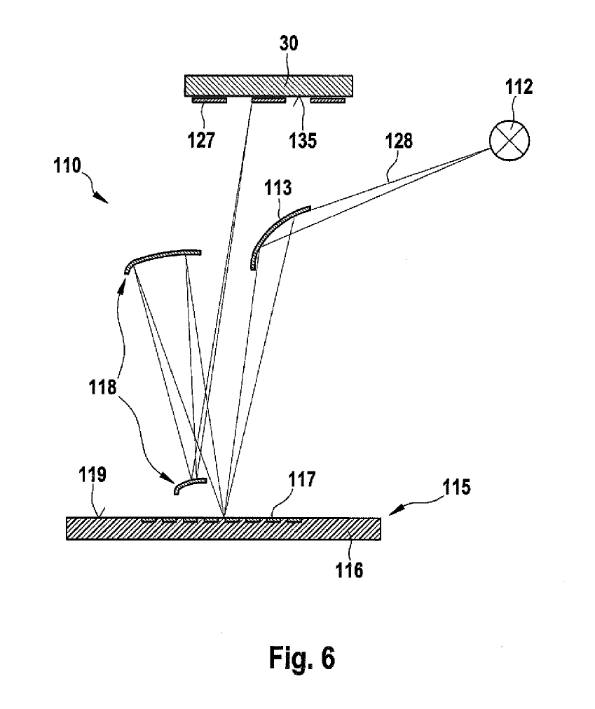

FIG. 6 shows an embodiment of a mask inspection device 110 according to the invention. This type of mask inspection device 110 serves to analyse mask defects on a test mask 115. The test mask 115 comprises a substrate 116 and mask structures 117 in the form of structured absorbers on its upper side 119. The mask inspection device 110 comprises a radiation source 112 for emitting electromagnetic radiation 128, in the present case in the EUV wavelength range, and illumination optics 113 for steering the radiation 128 onto an upper side 119 of the test mask 115 in the region of the mask structures 117. The radiation 128 reflected by the upper side 119 of the test mask 115 is guided by means of projection optics 118 onto a receiving surface 135 of the radiation detector 30 described above by means of FIGS. 3 to 5. Here the mask structures 117 are imaged, enlarged, on the receiving surface 135. The enlarged aerial image 127 of the mask structures 117 produced here is recorded, locally resolved, by means of the radiation detector 30.

For the analysis of mask defects, by means of the mask inspection device 110 a small region of the test mask 115 with the same illumination and imaging conditions as regards wavelength, numerical aperture (NA), illumination type and coherence level of the illumination light (Sigma) is illuminated and imaged as in the microlithography projection exposure tool. Unlike the projection exposure tool with which the mask structures are reduced when imaged on the wafer, the aerial image on the radiation detector 30 produced by the test mask 115 is enlarged. The radiation detector 30 sees the same latent image as the resist on the wafer. Therefore, conclusions regarding the printability of the test mask 115 can be drawn without costly test imaging by means of projection exposure tools.

### LIST OF REFERENCE NUMBERS

10 microlithography projection exposure tool
12 radiation source
14 object plane
16 measuring mask
18 projection objective
20 image plane
22 aerial image measuring device
24 measured object structure
26 optical axis
28 electromagnetic radiation
30 radiation detector
32 precision table
34 detector element
35 receiving surface
36 p zone
38 n zone
40 zone with low doping
42 evaluation apparatus
44 electric charge
46 integral preamplifier
48 trigger logic
50 adder
52 subtractor
54 electronic chip for forming a quotient
56 memory chip
58 electronic chip for reading out a quotient
60 analogue to digital converter
62 histogram memory
110 mask inspection device
112 radiation source
113 illumination optics
115 test mask
116 substrate
117 mask structures
118 projection optics
119 upper side
127 enlarged aerial image
128 electromagnetic radiation
135 receiving surface

1. A microlithography projection exposure tool with a radiation detector for the locally resolved recording of electromagnetic radiation, the radiation detector comprising:
a solid state body configured to multiply electric charge and
a collector configured to determine the location of the multiplied electric charge by charge division.

2. The microlithography projection exposure tool according to claim 1, wherein the radiation detector is designed for the locally resolved recording of electromagnetic radiation in the EUV wavelength range.

3. The microlithography projection exposure tool according to claim 1, which is designed to expose a semiconductor wafer with electromagnetic radiation in the EUV and/or higher frequency wavelength range.

4. The microlithography projection exposure tool according to claim 1, wherein the radiation detector has a photoelectric element configured to receive the electromagnetic radiation and to convert the received radiation directly into the electric charge.

5. The microlithography projection exposure tool according to claim 1, wherein, in one recording directions the radiation detector has an extension of maximum 20 μm.

6. The microlithography projection exposure tool according to claim 1, wherein the collector comprises a discrete electric component which has an extension in at least one recording direction and is configured to receive the multiplied electric charge at one location along the recording direction, and wherein the discrete electric component is configured to produce, by dividing the received multiplied electric charge into at least two part charges, an electric signal from which the site of the location within the extension of the component is determined.

7. The microlithography projection exposure tool according to claim 6, wherein the collector further comprises an evaluation apparatus configured to determine the site of the location from the electric signal.

8. The microlithography projection exposure tool according to claim 1, wherein the solid state body is configured to multiply the electric charge by at least a factor of 100.

9. The microlithography projection exposure tool according to claim 6, wherein the radiation detector is configured for the locally resolved recording of electromagnetic radiation with a predetermined local resolution, and the solid state body is configured to multiply the electric charge such that the overall number of resulting electric charge carriers is at least as great as the quotient of the extension of the discrete electric component and the local resolution.

10-11. (canceled)

12. The microlithography projection exposure tool according to claim 6, wherein the collector or the discrete electric component is formed integrally with the photoelectric element.

13. The microlithography projection exposure tool according to claim 6, wherein the local resolution of the collector or of the discrete electric component lies within the EUV wavelength range.

14. (canceled)

15. The microlithography projection exposure tool according to claim 4, wherein at least one of the photoelectric element, the solid state body and the collector or the discreet electric component is contained in a detector element in the form of a solid state body.

16-17. (canceled)

18. The microlithography projection exposure tool according to claim 15, wherein the detector element has an avalanche photodiode structure.

19. The microlithography projection exposure tool according to claim 1, wherein the radiation detector is configured to record the hit location of an individual photon of the electromagnetic radiation in at least one recording direction at a given point in time.

20. The microlithography projection exposure tool according to claim 19, further comprising an evaluation apparatus which has a histogram memory and is configured to record the respective hit location of individual photons of the electromagnetic radiation hitting the radiation detector and to input the recorded locations into the histogram memory, thereby recording a locally resolved hit frequency of the individual photons of the electromagnetic radiation.

21. The microlithography projection exposure tool according to claim 1, further comprising an aerial image measuring device containing the radiation detector which is configured for measuring an intensity distribution of electromagnetic radiation in a three-dimensional space.

22. The microlithography projection exposure tool according to claim 21, wherein the aerial image measuring device is configured to record the hit locations of individual photons of the electromagnetic radiation in a chronological sequence.

23-28. (canceled)

29. The microlithography projection exposure tool according to claim 1, further comprising an optical imaging device for imaging a product mask disposed in a mask plane on a semiconductor wafer disposed in a wafer plane, and a diffused light measuring apparatus for measuring a proportion of diffused light in the microlithography projection exposure device, the diffused light measuring apparatus comprising:
a measuring mask disposed in the mask plane with a test structure which attenuates the exposure radiation more strongly in relation to a mask region surrounding the test structure, and
the radiation detector which is disposed in the wafer plane in a dark region of the test structure in which decreased radiation intensity occurs in the wafer plane during imaging of the measuring mask due to the test structure.

30-31. (canceled)

32. The microlithography projection exposure tool according to claim 1, further comprising a wafer stage for movably holding a semiconductor wafer during exposure operation of the microlithography projection exposure tool, the at least one radiation detector being fixed to the wafer stage.

33-34. (canceled)

35. A microlithography projection exposure tool for exposing a semiconductor wafer with electromagnetic radiation in the EUV and/or higher frequency wavelength range comprising a radiation detector which is configured to record a hit location of an individual photon of the electromagnetic radiation at a given point in time.

36. A method for determining an imaging error of an optical imaging device of a microlithography projection exposure tool, comprising:
providing a radiation detector for the locally resolved recording of electromagnetic radiation, the radiation detector comprising a solid state body which multiplies electric charge and a collector which determines the location of the multiplied electric charge by means of charge division,
imaging a measured object structure by means of the imaging device,
placing the radiation detector in the path of the rays of the optical imaging device on the image side,
recording an intensity distribution of electromagnetic radiation produced by the imaging of the measured object structure by means of the radiation detector by converting the electromagnetic radiation produced by imaging the measured object structure into electric charge, multiplying the electric charge by means of the solid state body, and determining the location of the multiplied electric charge by means of the collector,
determining the imaging error of the optical imaging device by evaluating the recorded intensity distribution, and
removing the radiation detector from the path of the rays of the optical imaging device.

37. The method according to claim 36, wherein when imaged, the measured object structure is irradiated with electromagnetic radiation in the EUV wavelength range by means of the imaging device.

38. (canceled)

39. The method according to claim 36, wherein recording the intensity distribution of the electromagnetic radiation comprises:
recording the respective hit locations of individual photons of the electromagnetic radiation hitting the radiation detector, and
inputting the hit locations recorded into the histogram memory, thereby recording a locally resolved hit frequency of the individual photons of the electromagnetic radiation.

40. A mask inspection device for inspecting a lithography mask comprising a radiation detector, for the locally resolved recording of electromagnetic radiation, the radiation detector comprising:
a solid state body configured to multiply electric charge, and
a collector configured to determine the location of the multiplied electric charge by charge division.

41-61. (canceled)
